(19) United States
(12) Patent Application Publication
(10) Pub. No.: US 2007/0214714 A1
(43) Pub. Date: Sep. 20, 2007

(54) HYBRID GREENHOUSE

(76) Inventors: Patrice Harnois, Ste-Elizabeth (CA); Marc Coutu, St-Thomas-de-Joliette (CA); Yves Dube, Lourdes-de-Joliette (CA)

Correspondence Address: ST. ONGE STEWARD JOHNSTON & REENS, LLC, 986 BEDFORD STREET, STAMFORD, CT, 06905-5619, US

(21) Appl. No.: 11/682,617

(22) Filed: Mar. 6, 2007

Related U.S. Application Data
(60) Provisional application No. 60/778,909, filed on Mar. 6, 2006.

(51) Int. Cl. A01G 9/14

(52) U.S. Cl. 47/17

(57) ABSTRACT

A hybrid greenhouse comprising a base for installing the hybrid greenhouse on a surface, a space frame delimiting side faces and a top face for enclosing a space above the surface, at least one retractable transparent screen for at least partially shielding the space from the elements when extended, and a netting for preventing entry of insects into the space while allowing air to flow therethrough. The space frame is anchored to the base. The retractable transparent screen is retractably mounted to the space frame. The netting is mounted to the space frame for completely enclosing the space. The at least one retractable transparent screen is mounted between the removable netting and the space.

### CROSS-REFERENCE TO RELATED APPLICATIONS

This patent application claims the benefit of, under Title 35, United States Code, Section 119(e), U.S. Provisional Patent Application No. 60/778,909, filed Mar. 6, 2006.

### FIELD OF THE INVENTION

The present invention relates to greenhouses, screenhouses and the like for use in farming or horticulture. More specifically, the present invention relates to a hybrid greenhouse combining features of greenhouses and screenhouses.

### BACKGROUND OF THE INVENTION

Conventional greenhouses are formed of rigid transparent panes, usually supported by a frame. They are generally used to shelter plants from inclement weather, while the air, soil and plants therein are warmed by incident solar radiation. Greenhouses generally allow control of the interior humidity, temperature, transmitted sunlight and wind. As some farmers and horticulturists find conventional greenhouses expensive, cheaper products have been developed in the industry of vegetable farming products, as well as for use in developing countries.

Tents formed from netting such as mosquito nets, also called screenhouses, are also available. These screenhouses are widely used in warmer regions, such as South America and Mediterranean countries. However, screenhouses are known to expose plants to the elements and do not provide any control of the conditions inside the screenhouse. On the contrary, when the weather is milder, screenhouses let the plants be exposed to the natural outdoor weather, which can be very economical for the owners.

Some modular greenhouses are available, for example, with opening roofs, such as in U.S. Pat. No. 6,978,573 (VAN DER HEIJDEN), which attempts to address the lack of flexibility of conventional greenhouses. However, such greenhouses are far more complex, and hence expensive, than the afore-mentioned screen houses.

Also known in the art are greenhouses with tent-like coverings, for example, U.S. Pat. No. 4,416,928 (CARL) which disclose a cover structure covered by a plastic sheets which is shrunk and/or welded to a metal grid structure. Similarly, U.S. Pat. No. 3,375,831 (SERBUS) discloses a disposable tent-like covering comprising a disposable plastic sheet sandwiched between an inner and outer layer of perforate netting. U.S. Pat. No. 3,441,037 (TRANSEAU) discloses a portable cabana comprising a frame, a roof portion, removable exterior wall portions and a removable interior insect netting. In addition, U.S. Pat. No. 2,226,812 (GOLDBERG) discloses a plant protector for shielding a plant comprising a supporting frame, a wire-mesh dome and a translucent, waterproof hood covering the exterior of the dome.

Thus, there remains a need for a hybrid greenhouse which combines at least some of the advantages of both conventional greenhouses and netted tents.

Also known in the art are the following patents and published applications which also describe covered structures and the like: U.S. Pat. No. 3,869,827, U.S. Pat. No. 6,098,335, U.S. Pat. No. 6,192,643, U.S. Pat. No. 6,282,834, U.S. Pat. No. 6,758,014, U.S. Pat. No. 6,877,521, FR 2,598,881, US 2004/0049976, US 2004/0159346, US 2005/0072074, US 2005/0249917 and US 2006/0268544.

### SUMMARY OF THE INVENTION

It is an object of the present invention to fill some of the above-mentioned needs.

It is also an object of the present invention to provide a hybrid greenhouse which provides the protection and control of conventional greenhouses on the one hand, and the inexpensiveness and permeability of the tents on the other hand.

According to an aspect of the present invention, a hybrid greenhouse is provided comprising a base for installing the hybrid greenhouse on a surface, a space frame delimiting side faces and a top face for enclosing a space above the surface, at least one retractable transparent screen for at least partially shielding the space from the elements when extended, and a netting for preventing entry of insects into the space while allowing air to flow therethrough. The space frame is anchored to the base. The retractable transparent screen is retractably mounted to the space frame. The netting is mounted to the space frame for completely enclosing the space. The at least one retractable transparent screen is mounted between the removable netting and the space.

Preferably, the at least one retractable transparent screen is extendable along at least a portion of the top face. Preferably, the side faces comprise a pair of opposing longitudinally extending end faces and a pair of opposing laterally extending gabled faces, the top face comprises at least one pair of sloping portions which extend longitudinally between the gabled faces, and the at least one retractable transparent screen comprises a pair of opposing retractable transparent screens which each extend along a respective one of the sloping portions.

These and other aspects of the present invention will become more apparent upon reading the detailed description and upon referring to the following drawings.

### BRIEF DESCRIPTION OF THE DRAWINGS

FIG. 1 is a perspective, partially cut-away view of the hybrid greenhouse according to a preferred embodiment of the invention shown.

FIG. 2 is a side view of the hybrid greenhouse of FIG. 1.

FIG. 3 is a typical cross-section of the hybrid greenhouse of the previous Figures.

FIG. 4 is a cross-section of the hybrid greenhouse of the previous Figures taken at a gabled face.

FIG. 5 is a detailed view of the area V of FIG. 3.

FIG. 6 is a cross-section taken along VI of FIG. 3.

FIG. 7 is a detailed view of the area VII of FIG. 3.

FIG. 8 is a detailed view of the area VIII of FIG. 4.

FIG. 9 is a detailed view of area IX of FIG. 3.

FIG. 10 is a detailed view of area X of FIG. 3.

FIG. 11 is a detailed view of area XI of FIG. 3.

FIG. 12 is a detailed view of area XII of FIG. 3.

FIG. 13 is a cross-section taken along XIII of FIG. 3.

FIG. 14 is a cross-section taken along XIV of FIG. 4.

FIG. 15 is a cross-section taken along XV of FIG. 4.

FIG. 16 is a cross-section taken along XVI of FIG. 4.

### DETAILED DESCRIPTION OF THE INVENTION

While the invention will be described in conjunction with the exemplary embodiment, it will be understood that this are not intended to limit the scope of the invention to this embodiment. On the contrary, the invention is intended to cover all alternatives, modifications and equivalents as may be included as defined by the appended claims.

In the following description, similar features in the drawings have been given similar reference numerals and in order to lighten the figures, some elements are not referred to in some figures if they were already identified in a precedent figure.

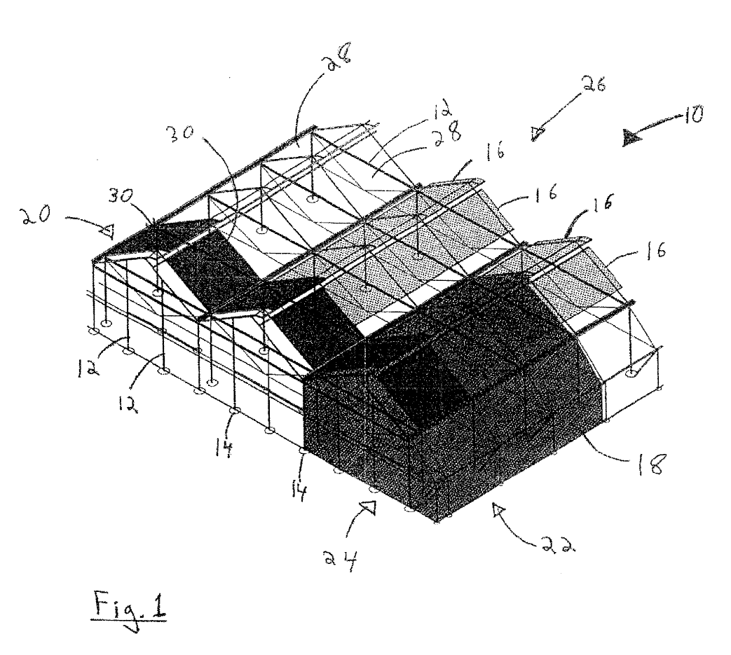

Referring to FIG. 1, a hybrid greenhouse 10 according to a preferred embodiment of the invention is illustrated with several elements partially cut-away to increase clarity. The hybrid greenhouse comprises a rigid space frame 12 mounted on a base 14, at least one retractable screen 16 and a netting 18. The space frame 12 is preferably formed of circular or oval metal tubing, or indeed a combination of both. The base 14 is preferably formed of a plurality of concrete plugs set into the ground just below the surface upon which the hybrid greenhouse 10 is installed, although a solid concrete foundation or other form of foundation is also within the scope of the present invention.

The space frame 12, which is anchored to the base 14, encloses a space above the surface within a set of side faces 20, 22 and 24 and a top face 26 delimited by the space frame 12. The side faces 20 and 22 are preferably a pair of opposing faces which extend longitudinally. The side face 24 extends laterally and, for the sake of clarity, the corresponding side face which is opposite the side face 24 and completes the four side faces of the space frame 12 has not been shown. It will be apparent to one of ordinary skill in the art that this non-illustrated side face is simply a mirror-image of the side face 24.

The top face 26 is preferably formed by a series of longitudinally extending portions 28 sloping towards each other in pairs. These pairs of sloping portions 28 form a substantially triangular wave-like pattern of alternating peaks and valleys, which extend laterally across the hybrid greenhouse 10, as is known in the art. The side face 24, which extends from the ground to the edge of the sloping portions 28, is therefore also called a gabled face 24 as its upper edge follows the alternating peaks and valleys of the top face 26.

The retractable screens 16 are retractably mounted to the space frame in order to at least partially shield the space contained within the space frame 12 from the elements when extended. Preferably, the retractable screens 16 are extendable along the sloping portions 28 such that, when extended, the screens 16 cover a substantial portion of the top face, thereby protecting the contents of the hybrid greenhouse 10 from heavy rain, hail, snow, and other natural events.

As will be discussed in further detail below, the retractable screens 16 are preferably fixed to the sloping portions 28 along their upper, longitudinally extending edges at respective peaks of the top face 26, and extended downwardly towards the valleys when so desired. Preferably, the screens 16 are impermeable UV-stabilized polyethylene sheets which are extended by rolling them up and down the sloping portions 28. In use, the lower, free end of each roll-up polyethylene sheet 16 is rolled onto itself or a longitudinally extending cylinder as it is rolled up (retracted) or unrolled down (extended) along the sloping portions 28. Preferably, the roll-up polyethylene sheet 16 is electromechanically controlled, that is a user may actuate the extension/retraction of the sheets 16 with an electrical switch or remote. For example, guided electric motors may be installed at either longitudinal extremity of the end-rolls 66 (see FIG. 7) and used to roll and unroll the sheets 16. Alternatively, the sheets 16 may be actuated manually or by purely mechanical mechanisms.

As will be readily appreciated by one skilled in the art, the screens 16 are preferably provided along each of the sloping portions 28. This is in contrast to the hybrid greenhouse 10 illustrated in FIG. 1, which has been partially cut-away for the sake of clarity.

Similarly, the netting 18 preferably extends over the entirety of the side faces 20 and 22, the gabled faces 28 and the top face 28 so as to completely enclose the space frame 12. In this way, it is operable to protect the contents of the hybrid greenhouse 10 from entry of insects and other, large airborne nuisances. The netting 18 also permits air to flow through the hybrid greenhouse 10, which can be advantageous in warm climates.

The netting 18 is the outermost layer covering the hybrid greenhouse 10. Advantageously, the netting 18 helps stabilize and retain the screens 16, which could otherwise be blown away in high winds.

Beneath each screen 16 is at least one end skirt 30 for guiding the screens 16 during extension and retraction. Preferably, a pair of end skirts 30 are fixed to the space frame 12 at either longitudinal end of each sloping portion 28 such that the longitudinal ends of the screens 16 are loosely sandwiched between the end skirts 30 and the netting 18. The end skirts 30 are also preferably made of a transparent impermeable UV-stabilized polyethylene material.

With reference to FIG. 2, the gabled face 24 of the hybrid greenhouse 10 of FIG. 1 is shown. In addition to further illustrating the concrete plugs 14 into which the space frame 12 is mounted, a vent 32 is shown substantially at the peak of the top face 26, as is commonly provided in the art. As is known in the art, and well within the scope of the present invention, vents 32 may alternatively, or additionally, be provided along one or more of the side faces 20, 22 and 24.

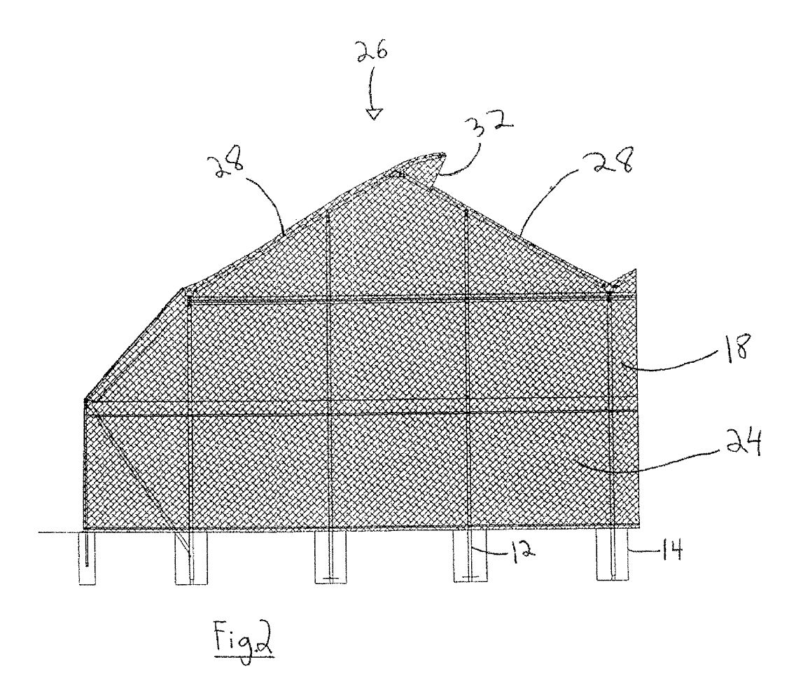

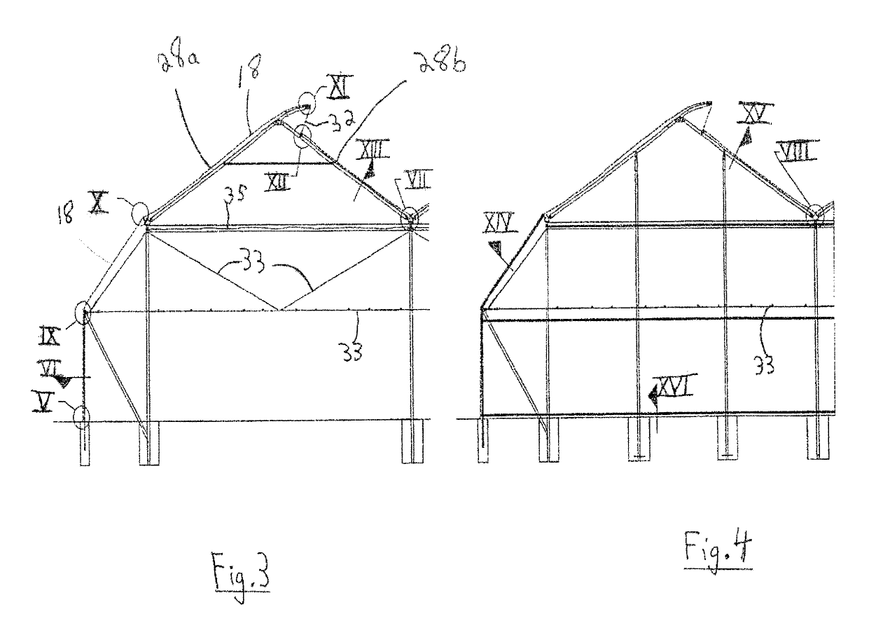

FIG. 3 shows a typical cross-section of the hybrid greenhouse 10, while FIG. 4 shows an equivalent cross-section directly before the gabled face 24. This distinction will become more apparent upon description of the detailed views in FIGS. 5 and 7-12 and the cross-sectional view in FIGS. 6 and 13-16. Additionally shown are wires 33 which are used as tension members within the space frame 12, as is common in the art, and an extendable shade 35 which can be optionally extended horizontally across the hybrid greenhouse 10.

The detail illustrated in FIG. 5 shows a vertical frame member 34 of the space frame 12. The vertical frame member 24 is in the form of a circular tube and set into the concrete base 14. The netting 18 is retained proximate the base of a longitudinal face, such as end faces 20 and 22 by a connector 36. The connector 36 is preferably a combination of wirelock and wire-plast connectors, although other connecting means and combinations of connecting means, such as clips, snaps, bolts, screws, adhesives and staples are well within the scope of the invention. Each connector 36 preferably comprises a self-drilling screw 37 for fixing a wirelock 39 to the vertical member 34 and wire-plast 41 force-fit into the wirelock 39.

The connector 36 retains the netting 18 to a square tubing 38 which is bolted to the tube 34 and extends longitudinally across the space frame 12. As such, the netting 18 is retained along the bottom edge of the hybrid greenhouse 10. A free end 40 is illustrated hanging below the connector 36.

The cross-section illustrated in FIG. 6 shows another connector 36 attached directly to the vertical tube 34, with the square tube 38 shown extending longitudinally beneath it.

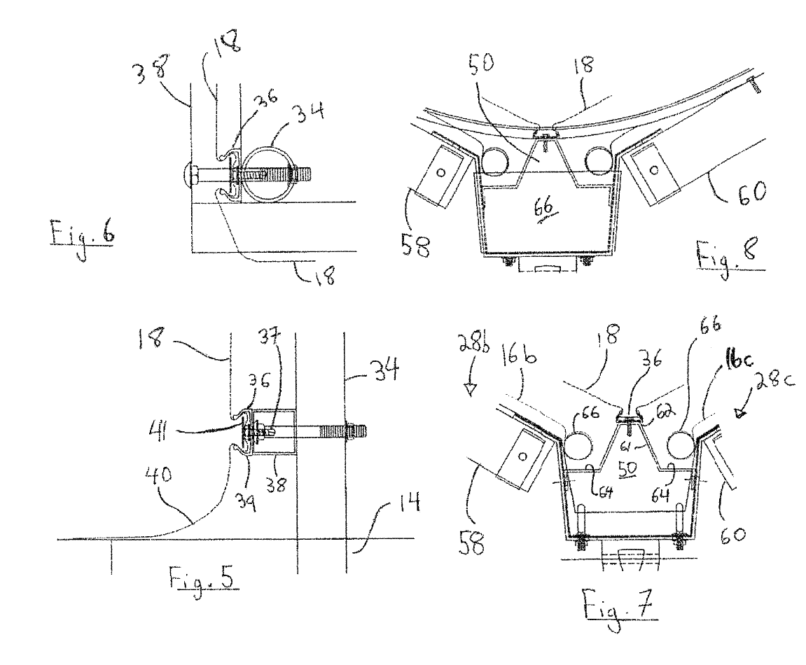

With reference now to the details illustrated in FIGS. 9 and 10, the netting 18 is retained with connectors 36 at two more points an end face of the space frame 12. In FIG. 9, the upper end 42 of the vertical tube 34 is joined to a longitudinally extending member 44. The netting 18 is retained to member 44, which is a substantially ovoid tube running parallel to the aforementioned square tube 38, by a connector 36. In FIG. 10, a connector 36 is used to retain the netting 18 to an extremity of a gutter 50, which will be discussed in further detail with reference to FIG. 7.

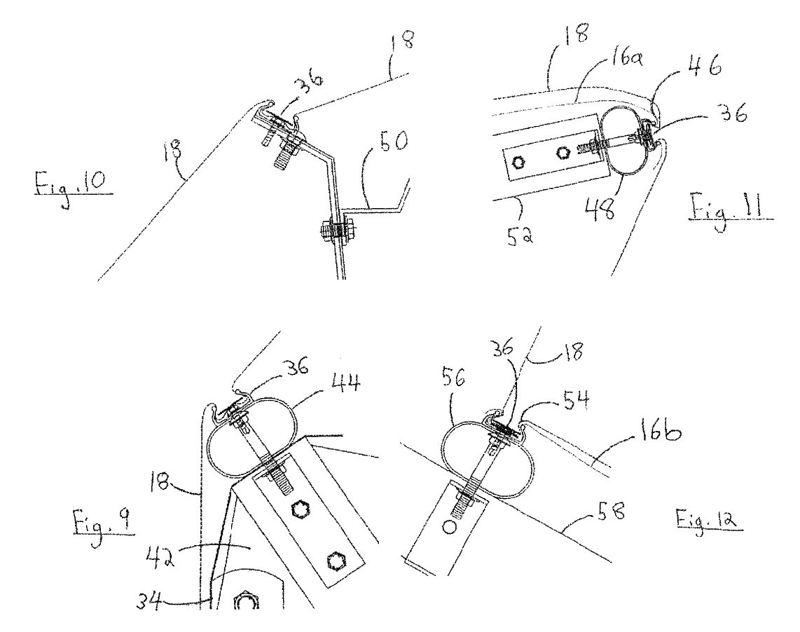

As will be appreciated from FIG. 3, between FIGS. 10 and 11 is a first sloping portion 28a. In FIG. 11, a first roll-up polyethylene sheet 16a is shown fixed along its upper edge 46 by the same connector 36 which retains the netting 18 to a longitudinally extending ovoid tube 48. As will be appreciated with by one of ordinary skill in the art, the upper edge 46 of the sheet 16a may be fixed to the space frame 12 in a variety of other ways without departing from the scope of the invention. For its part, the longitudinally extending tube 48 is mounted at the end of a sloping tube 52 which extends laterally and downwardly as a rafter would in a conventional sloping roof. The first sheet 16a is unrolled such that it extends towards the gutter 50 in FIG. 10 along the laterally extending tube 52. Below the tube 48 is the vent 32. Consequently, while the netting 18 extends on both sides of the connector 36, the sheet 16a does not.

Continuing downward now to detail illustrated in FIG. 12, the uppermost edge of a second sloping portion 28b is shown. Similarly, a second roll-up polyethylene sheet 16b is fixed along its upper edge 54 by a connector 36 which also retains the netting 18 to a longitudinally extending ovoid tube 56. The tube 56 is itself attached to another sloping tube 58. The second sheet 16b is unrolled along the tube 58 which extends the length of the second sloping portion 28b towards a gutter shown in FIG. 7.

The detail illustrated in FIG. 7, for its part, shows a gutter 50 which forms a valley in the top face 26 between the second sloping portion 28b and a third sloping portion 28c. The gutter 50 fixes the lower ends of two sloping tubes 58 and 60 to the rest of the space frame 12. As is known in the art, the gutter 50 is also operable to collect run-off from the sloping portions. An insert 61 is positioned in the gutter 50 and comprises a raised portion 62 between a pair of recessed portions 64. The recessed portions 64 of the gutter 50 are operable to receive the end-rolls 66 of roll-up polyethylene sheets 16b and 16c when fully extended. The raised portion 62 is provides a raised position on which to fix the netting 18, via a connector 36. The raised and recessed portions 62 and 64 are arranged such that the netting 18 does not interfere with the extension and retraction of the roll-up polyethylene sheets 16. Preferably, each gutter 50 includes a number of the inserts 61 along its longitudinal length for retaining the netting 18. Run-off is then collected in the gutter 50 below the insert 61 and does not interfere with the end-rolls 66 when fully extended.

The detail illustrated in FIG. 8 shows substantially the same cross-section as FIG. 7 with the addition of a gutter plate 66 which is provided at the end of the gutter 50.

The cross-section illustrated in FIG. 13 shows the sloping tube 58 of FIGS. 7, 8 and 12 and a similar longitudinally spaced equivalent tube 68, which also slopes transversally. In this case, these two tubes 58 and 68 delimit a longitudinal end of a sloping portion 28. An end skirt 30 extends between the tubes 58 and 68 and is fixed on opposite sides by connectors 36. Although not illustrated in this Figure, the roll-up polyethylene sheet 16b is disposed thereabove. In use, the sheet 16b is rolled and unrolled on this end skirt 30 and another end skirt 30 at its opposite longitudinal end.

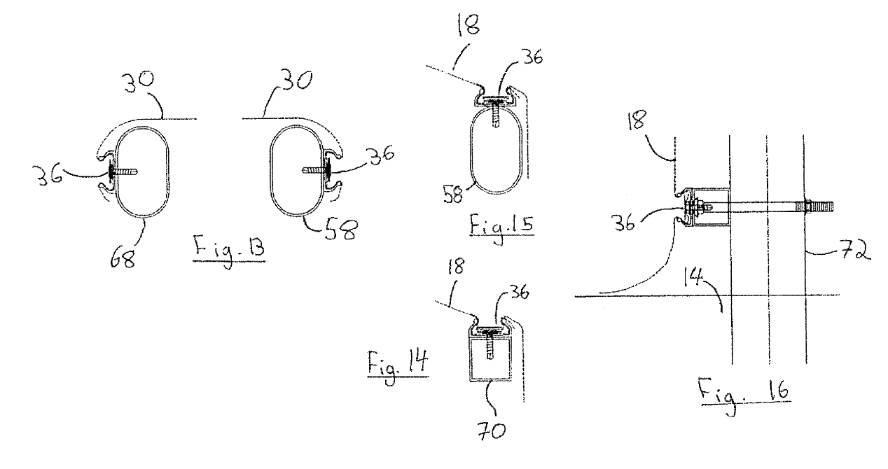

The cross-sections illustrated in FIGS. 14 and 15 show the netting 18 fixed to tubing 70 and 58, respectively, at the intersection of a sloping portion and a gable end, such as the longitudinally extending sloping portion 28a and the laterally extending gabled face 24, by connectors 36.

Similar to FIG. 5, the cross-section illustrated in FIG. 16 shows a vertical frame member 72 of the space frame 12 set into a concrete base 14 and restraining the netting 18 by a connector 36 along a laterally extending face, such as gabled face 24.

The tubing utilized in constructing the space frame 12 is preferably made of pre-galvanized steel with a minimum yield of 300 MPa, thus the expected life length of such structure is about 25 years in rural conditions. The moulded components of the structure are preferably made of extruded aluminium, for example 6063-T5, T54 or T6 grades. Multi-strands steel cables are suitable for the steel wires 33, and it is recommended to use A325-type anti-galvanic-corrosion bolts which may be functional for over 1000 hours even in a saline mist. These technical specifications will be understood by a person skilled in the art and should not be considered as limiting the scope of the present invention.

The hybrid greenhouse 10 disclosed herein allows the complete protection of plants from insects. The netting 18 further can also serve as a windbreaker in high winds.

Moreover, the retractable screens 16 are operable to, inter alia, protect vulnerable plants such as tomatoes and cucumbers from heavy rains, which could otherwise damage the plants and consequently reduce their yield.

In addition, it should be noted that a disadvantage of mesh fabrics such as mosquito nets, and other anti-insect nets of the like, is that they gather dust. In conventional hybrid products combining a netting layer and an impermeable sheet layer, the sheet layer is generally provided outside the netting layer. In contrast, the netting 18 of the hybrid greenhouse 10 is provided as the outermost layer and as such is washed by the rain.

The above description of preferred embodiments of the present invention should not be read in a limitative manner as refinements and variations are possible without departing from the spirit of the invention. The scope of the invention is defined in the appended claim and its equivalents.

What is claimed is:

1. A hybrid greenhouse comprising:
a) a base for installing the hybrid greenhouse on a surface;
b) a space frame delimiting side faces and a top face for enclosing a space above the surface, the space frame being anchored to the concrete base;
c) at least one retractable transparent screen for at least partially shielding the space from the elements when extended, the retractable transparent screen being retractably mounted to the space frame; and
d) a netting for preventing entry of insects into the space while allowing air to flow therethrough, the netting being mounted to the space frame for completely enclosing the space;
wherein the at least one retractable transparent screen is mounted between the removable netting and the space.

2. The hybrid greenhouse of claim 1, wherein the at least one retractable transparent screen is extendable along the top face.

3. The hybrid greenhouse of claim 2, further comprising at least one end skirt fixed to the space frame between the space and the at least one retractable transparent screen, the at least one end skirt operable to guide the extension of the at least one retractable transparent screen.

4. The hybrid greenhouse of claim 3, wherein:
the side faces comprise a pair of opposing longitudinally extending end faces and a pair of opposing laterally extending gabled faces; the top face comprises at least one pair of sloping portions, the sloping portions extending longitudinally between the gabled faces; and
the at least one retractable transparent screen comprises a pair of opposing retractable transparent screens, each retractable transparent screen extendable along a respective one of the sloping portions.

5. The hybrid greenhouse of claim 4, wherein the at least one end skirt is a pair of end skirts positioned at either longitudinal end of each retractable transparent screen.

6. The hybrid greenhouse of claim 6, wherein the at least one pair of sloping portions comprises a plurality of pairs of sloping portions; the plurality of pairs of sloping portions each extending longitudinally between the gabled faces.

7. The hybrid greenhouse of claim 1, further comprising a gutter comprising a raised portion and a recessed portion, the netting being fixed to the raised portion.

8. The hybrid greenhouse of claim 1, wherein the base is made of concrete.
